(19) United States
(12) Patent Application Publication
(10) Pub. No.: US 2007/0201408 A1
(43) Pub. Date: Aug. 30, 2007

(54) Apparatus, method and computer program product providing a transport format that is compatible with another transport format that uses spreading codes

(75) Inventors: Esa Tiirola, Kempele (FI); Kari Pajukoski, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/703,986

(22) Filed: Feb. 8, 2007

Related U.S. Application Data
(60) Provisional application No. 60/771,911, filed on Feb. 8, 2006.

(51) Int. Cl. H04B 7/216; H04J 3/22

(52) U.S. Cl. 370/335; 370/468; 370/441

(57) ABSTRACT

Either a first transport format or a second transport format is selected to transmit information corresponding to an input symbol sequence. The transport formats fit information into a timeslot having a predetermined duration. Based upon the selected transport format, either the information is created from the input symbol sequence using the first transport format or is created from the input symbol sequence using the second transport format. Creating the information for transmission using the first transport format applies a spreading code to the input symbol sequence. The information for transmission is transmitted in a selected timeslot having the predetermined duration. Creating and transmitting the information using the first transport format causes the transmitted information to occupy a first frequency band. Creating and transmitting the information using the second transport format causes the transmitted information to occupy a second frequency band that partially overlaps the first frequency band.

### CROSS-REFERENCE TO RELATED APPLICATIONS

The present application claims the benefit under 35 U.S.C. §119(e) of U.S. Provisional Patent Application No. 60/771,911, filed on 8 Feb. 2006, the disclosure of which is hereby incorporated by reference in its entirety.

### TECHNICAL FIELD

The exemplary and non-limiting embodiments of this invention relate generally to wireless communications systems, methods and devices and, more specifically, relate to transmissions from a user equipment to a base station and receptions by a base station in a system that uses codes to multiplex users.

### BACKGROUND

The following abbreviations are herewith defined:

| | |
|---|---|
| CDMA | code division multiple access |
| CP | cyclic prefix |
| DPCCH | dedicated physical control channel |
| DS | direct spread |
| FBI | feedback information |
| FDMA | frequency division multiple access |
| FDPA | frequency division pilot access |
| HARQ | hybrid automatic repeat request |
| HSUPA | high speed uplink packet access |
| IFDMA | interleaved FDMA |
| IC | interference cancelling |
| IRC | interference rejection combining |
| LMMSE | linear minimum mean squared error |
| LTE | long term evolution |
| MIMO | multiple input, multiple output |
| MPIC | multipath PIC |
| PAR | peak-to-average power ratio |
| PC | power control |
| PIC | parallel interference cancellation |
| QPSK | quadrature phase shift keying |
| SC | single carrier |
| SW | software |
| TFCI | transport format combination indicator |
| TPC | transmission power control |
| TTI | transmission time interval |
| UE | user equipment |
| UL | uplink |
| UMTS | universal mobile telecommunication system |
| UTRAN | UMTS terrestrial radio access network |
| VoIP | voice over internet protocol |
| VSCRF | variable spreading and chip repetition factors |
| WCDMA | wideband CDMA |

A problem exists in that the WCDMA (HSUPA) transport format is not particularly suitable for use at high data rates. Further, equalization problems exist with high modulation orders even with advanced receivers such as LMMSE and MPIC. Further, a Rake receiver does not work at all in a severe multipath channel with 16QAM. There is also a PAR problem with the use of multicodes.

An additional problem that arises relates to WCDMA and HSUPA in that the system is interference limited as the simultaneous users interfere with one another. The only practical conventional technique to orthogonalize different users in WCDMA and HSUPA is to utilize complex IC receivers. However, the use of practical IC receivers is not optimum from at least an implementation and complexity perspective.

In the current implementation of the UL, different users are separated using spreading codes and, as a result, they are completely non-orthogonal (being non-synchronized at the BS receiver and/or having experienced frequency selective channel). The interference is suppressed by the use of spreading codes. In next generation systems such as UTRAN LTE and WiMax FDMA access between users has been proposed. Capacity gains of the order of 100 to 200 percent for UTRAN LTE, as compared to HSUPA, have been shown.

On the other hand it has been shown that by using an optimal IC receiver WCDMA could provide almost similar performance figures as the UTRAN LTE. However, and as was noted above, the complexity of optimal IC receivers makes their use in a practical system less than optimum. In an orthogonal system such as UTRAN LTE one drawback to the use of IC receiver, as compared to non-orthogonal systems, is the increased amount of control information that needs to be transmitted over the wireless link, as the time varying orthogonal resources need to be frequently signaled to each UE. The overhead of this control information can become significant if there are multiple simultaneous real time or almost real time users, such as VoIP users.

In general, it can be shown that advanced receivers such as the IC and IRC do not provide a very significant gain in the WCDMA UL due to the large number of simultaneous users.

A problem with the IC receiver is that the complexity increases significantly if there are several users to be cancelled. The implementation complexity of an optimal interference canceller (see, for example, third generation partnership project (3GPP) technical report (TR) 25.814, “Physical Layer Aspects for Evolved UTRA”) is an exponential function of the number of users, and as a consequence it is not feasible for most practical receivers. Also, the efficiency of practical PIC is better when there are very few high bit rate interferers to be cancelled, as opposed to a large number of low bit rate interferers, e.g., 64 to 384 kbit/s users.

With the IRC receiver the problem is that the large numbers of low data rate users (e.g., speech users) tend to make the interference appear to be spatially white. The best performance with the IRC receiver is obtained when the interference is spatially colored, e.g., with a single very high bit rate interferer. However, this is not a typical interference scenario in the WCDMA UL. In addition, with the IRC receiver the number of signals that can be rejected depends on the number of receiving antennas in such a way that N-1 complex interferers can be nulled with N receiving antennas.

### BRIEF SUMMARY

In an exemplary embodiment, a method is disclosed that includes selecting either a first transport format or a second transport format to transmit information corresponding to an input symbol sequence. Each of the transport formats fit information for transmission into a timeslot having a predetermined duration. Based upon the selected transport format, either the information for transmission is created from the input symbol sequence using the first transport format or the information for transmission is created from the input symbol sequence using the second transport format. Creating the information for transmission using the first transport format includes applying at least one spreading code to the input symbol sequence. The information for transmission is transmitted in a selected timeslot having the predetermined duration. Creating and transmitting the information using the first transport format causes the transmitted information to occupy a first frequency band. Creating and transmitting the information using the second transport format causes the transmitted information to occupy a second frequency band that at least partially overlaps the first frequency band.

In another exemplary embodiment, an apparatus includes a controller configured to select either a first transport format or a second transport format to transmit information corresponding to an input symbol sequence. Each of the transport formats fits information for transmission into a timeslot having a predetermined duration. The apparatus includes at least one transmitter configured, responsive to the controller and based upon the selected transport format, either to create the information for transmission from the input symbol sequence using the first transport format or to create the information for transmission from the input symbol sequence using the second transport format. The at least one transmitter is configured, when creating the information for transmission using the first transport format, to apply at least one spreading code to the input symbol sequence. The at least one transmitter is configured to transmit the information for transmission in a selected timeslot having the predetermined duration. Creation and transmission of the information using the first transport format causes the transmitted information to occupy a first frequency band. Creation and transmission of the information using the second transport format causes the transmitted information to occupy a second frequency band that at least partially overlaps the first frequency band.

In an additional exemplary embodiment, a computer program product tangibly embodies a program of machine-readable instructions executable by at least one data processor to perform operations. The operations include selecting either a first transport format or a second transport format to transmit information corresponding to an input symbol sequence, each of the transport formats fitting information for transmission into a timeslot having a predetermined duration. The operations include, based upon the selected transport format, either creating the information for transmission from the input symbol sequence using the first transport format or creating the information for transmission from the input symbol sequence using the second transport format. Creating the information for transmission using the first transport format includes applying at least one spreading code to the input symbol sequence. The operations include transmitting the information for transmission in a selected timeslot having a predetermined duration. Creating and transmitting the information using the first transport format causes the transmitted information to occupy a first frequency band. Creating and transmitting the information using the second transport format causes the transmitted information to occupy a second frequency band that at least partially overlaps the first frequency band.

In a further exemplary embodiment, a method includes receiving first information using a first transport format. The first information is received in a timeslot having a predetermined duration, wherein the first information occupies a first frequency band. The method includes converting, at least by applying at least one spreading code to the received first information, the received first information to first output data. The method includes receiving second information using a second transport format, the second information received in a timeslot having the predetermined duration. The second information occupies a second frequency band that at least partially overlaps the first frequency band. The first and second information are received at the same time in a selected timeslot. The method includes converting the received second information to second output data.

In another exemplary embodiment, an apparatus includes a first receiver configured to receive first information using a first transport format and to convert, at least by application of at least one spreading code to the received first information, the received first information to first output data. The first information is received in a timeslot having a predetermined duration, wherein the first information occupies a first frequency band. The apparatus includes a second receiver configured to receive second information using a second transport format and to convert the received second information to second output data. The second information is received in a timeslot having the predetermined duration, wherein the second information occupies a second frequency band that at least partially overlaps the first frequency band, and wherein the first and second information are received at the same time in a selected timeslot.

A further exemplary embodiment includes an apparatus that includes at least one transmitter configured to create information for transmission from an input symbol sequence using a first transport format. The at least one transmitter is configured to transmit the information for transmission in a timeslot having a predetermined duration. Creation and transmission of the information using the first transport format causes the transmitted information to occupy a first frequency band that at least partially overlaps a second frequency band occupied when a second transport format is used by other apparatus to transmit information within a timeslot having the predetermined duration. Creation of the information uses a user-specific code that provides orthogonality of the transmitted information relative to information created and transmitted using other user-specific codes. Transmissions using the second transport format multiplex users through non-orthogonal user-specific spreading codes.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 shows a comparison for WCDMA using a LMMSE chip equalizer and Cyclic Single Carrier transmission using a frequency domain equalizer, for a single user case, a 0.5 TTI, two receive antennas, QPSK, 16 QAM modulation and power control turned off.

FIG. 2A shows the structure of one timeslot in accordance with the cyclic transport format.

FIG. 2B illustrates a frequency domain representation of the cyclic transport format in relation to WCDMA HSUPA signals within a 5 MHz frequency band.

FIG. 2C shows a time domain representation of the cyclic transport format and the WCDMA transmission scheme.

FIG. 2D shows the cyclic transport format combined with the DPCCH of WCDMA.

FIG. 3 shows an example related to realizing orthogonal multiple access between the UEs using the cyclic transport format for a FDPA-DS-CDMA embodiment herein.

FIG. 4A shows an example related to realizing orthogonal multiple access between the UEs using the cyclic transport format for an IFDMA embodiment.

FIG. 4B shows an exemplary result of using the symbol repetition and compression FIG. 4A after modulation (e.g., spreading) using user-specific phase vectors for two users.

FIG. 4C shows an exemplary result of using the symbol repetition and compression FIG. 4A after modulation using user-specific phase vectors for a single user.

FIG. 5 is a simplified block diagram of an UL receiver that is suitable for use with the cyclic transport format in accordance with exemplary embodiments of this invention.

FIG. 6A shows a performance example assuming the conditions listed in the Table of FIG. 6B.

FIG. 7 depicts a performance example of the cyclic transport format in accordance with exemplary embodiments of this invention in the context of IRC.

FIG. 8 shows a simplified block diagram of various electronic devices that are suitable for use in practicing the exemplary embodiments of this invention.

FIG. 9 shows a flowchart of an exemplary method to realize the orthogonal multiple access between UEs using the cyclic transport format, and to transmit spread and mapped data, as shown in FIG. 3.

FIG. 10 shows an exemplary transmitter suitable for generating cyclic transport format data as described in reference to FIG. 3 and also suitable for generating WCDMA data and for transmitting the generated data.

FIG. 11 shows a flowchart of an exemplary method to realize the orthogonal multiple access for UEs using the cyclic transport format, and to transmit data, of FIGS. 4A-4C.

FIG. 12 shows an exemplary transmitter suitable for generating cyclic transport format data as described in reference to FIGS. 4A-4C and also suitable for generating WCDMA data and for transmitting the generated data.

FIG. 13 shows a flowchart of an exemplary method for a UE to transmit using either WCDMA or a cyclic transport format described herein.

FIG. 14 is a flowchart for despreading data transmitted using the techniques of FIGS. 3 and 9.

FIG. 15 is a flowchart for despreading data transmitted using the techniques of FIGS. 4A-4C and 11.

FIG. 16 is a flowchart of a method for creating and transmitting data using either a WCDMA transport format or cyclic transport format.

### DETAILED DESCRIPTION OF EXEMPLARY EMBODIMENTS

The exemplary embodiments of this invention provide solutions to the foregoing problems through the use of a “cyclic transport format”, which includes use of cyclic prefixes, for the WCDMA UL. The cyclic transport format allows the usage of a simple frequency domain equalizer at the receiver, which is robust in the presence of Inter Path Interference, and that also offers enhanced performance with high data rates. In addition, the use of multicodes can be avoided with the use of the cyclic transport format in the WCDMA UL. Furthermore exemplary embodiments of cyclic transport format described herein provide a way to arrange multiple UEs utilizing the cyclic transport format to be mutually orthogonal against each other.

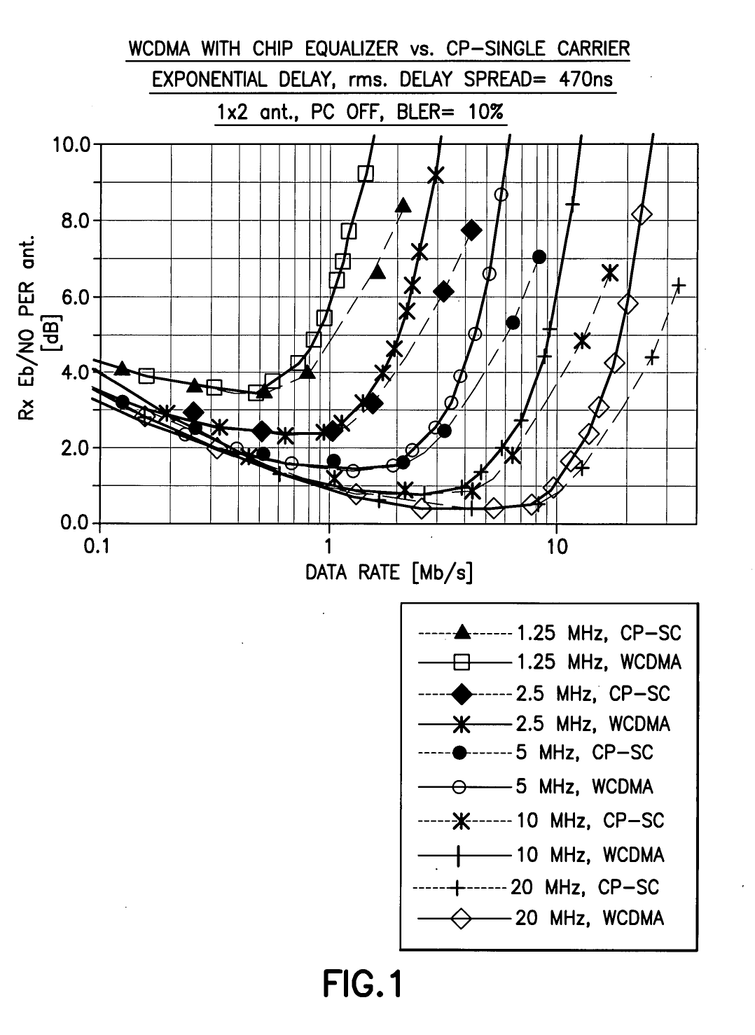

It is noted that a cyclic transport format is known (e.g., in a single carrier transmission). A cyclic transport format allows the use of simple frequency domain equalizer, which is resistive against Inter Path Interference and offers high performance with high data rates. This can be seen in FIG. 1 which compares the Eb/No performance of WCDMA using a complex time domain LMMSE chip equalizer and a cyclic single carrier transmission using a simpler frequency domain equalizer.

The exemplary embodiments of this invention are directed at least in part to the third generation UL evolution based on WCDMA (HSUPA). An exemplary goal is to ensure that the UL performance of the WCDMA evolution is competitive against competing technologies such as WiMax, Flarion, 3GPP2 evolution and UTRAN LTE. To this end, herein disclosed are an exemplary cyclic transport format and exemplary spreading and mapping techniques that use the cyclic transport format and that enable contemporaneous use of WCDMA.

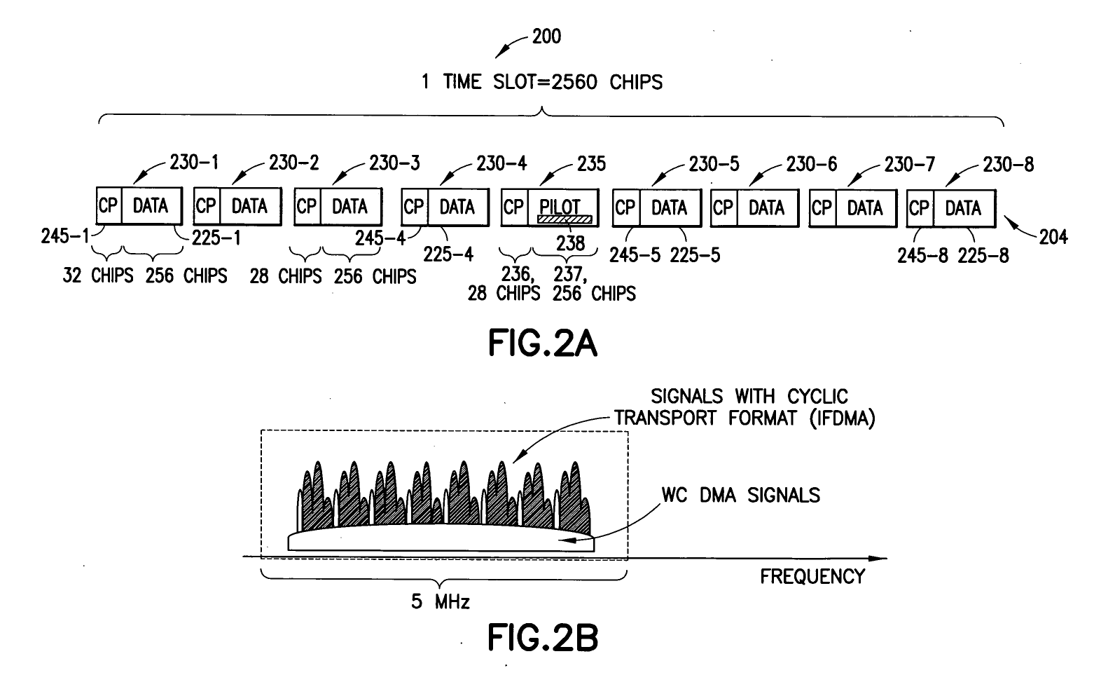

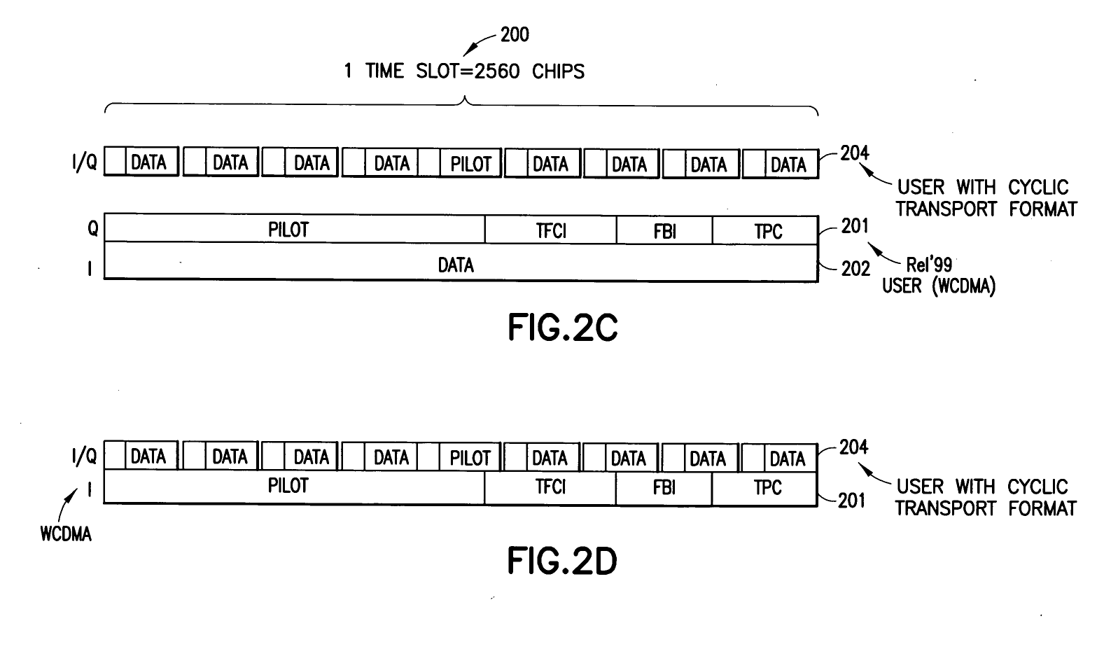

Referring to FIG. 2A, the specifics of a cyclic transport format in accordance with exemplary embodiments of this invention include, as non-limiting examples: eight data symbols (called data blocks 230, including data blocks 230-1 through 230-8) and one pilot symbol (called a pilot data block 235) per timeslot 200. The data blocks 230 and pilot data block 235 are the timeslot data 204. Each data block 230 includes a cyclic prefix 245 (including cyclic prefixes 245-1 through 245-8) and a data portion 225 (including data portions 225-1 through 225-8). The pilot data block 235 includes a cyclic prefix 236 and a pilot data portion 237. One timeslot 200=(9*256+8*28+1*32) chips=2560 chips; a timeslot duration=0.66666 milliseconds (ms) (⅔ ms) and a chip rate=2560 chips/0.66666 ms=3.84 Mchips/s (million chips per second). The overall pilot allocation of the waveform is about 11 percent, and the CP duration is about 7.3 microseconds, or 28 chips (the first CP: 8.3 microseconds, 32 chips). The peak data rate is 10.24 Mb/s (assuming 16QAM, ⅚). Note that these specific values are compatible with WCDMA/HSUPA parameters, and are furthermore intended to be read as exemplary, and to not limit the use or practice of the exemplary embodiments of this invention. The pilot data portion 237 of the pilot data block 235 includes in this example a reference signal 238. Reference signals are typically CAZAC (Constant Amplitude Zero Autocorrelation) sequences. Orthogonal reference signals (e.g., for each UE) can be provided by means of IFDMA (e.g., every eighth pin) or by means of CDMA (e.g., utilizing different cyclic shifts of a CAZAC sequence).

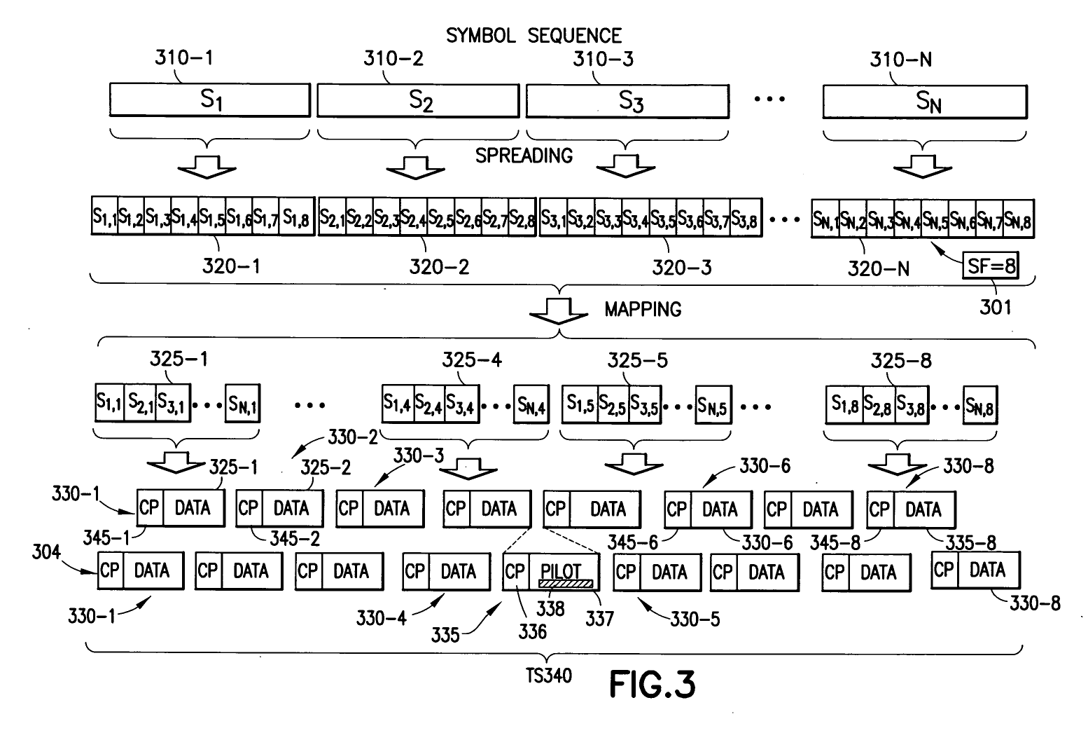

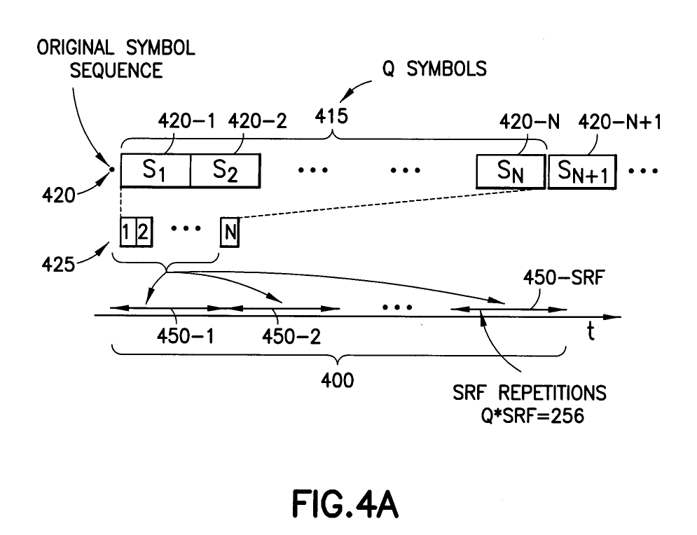

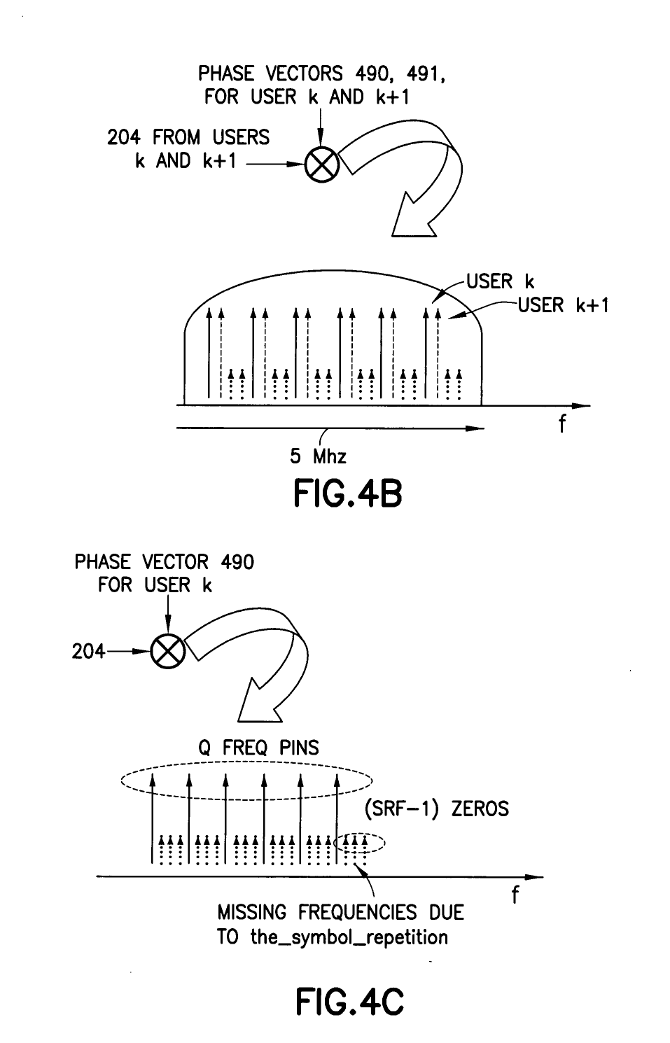

In accordance with the exemplary embodiments of the invention, and referring to FIG. 2B, WCDMA (HSUPA) users (using the timeslot data 201 and 202) and those users utilizing the cyclic transport format (using the timeslot data 204) can be multiplexed into the same frequency band. Both transport formats may be used simultaneously. FIG. 2B is an example of IFDMA (described with respect to FIGS. 4A-4C, 11, and 12), but the example of Frequency Division Pilot Access DS CDMA (described with respect to FIGS. 3, 9, and 10) would also allow both transport formats to be used simultaneously.

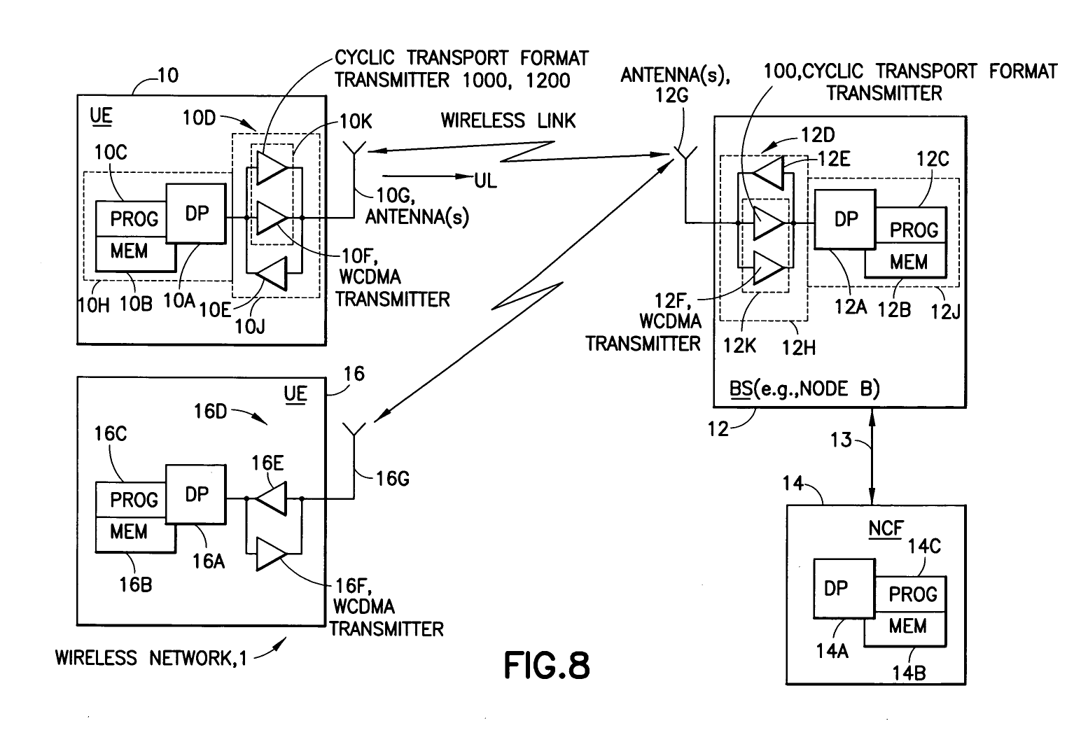

FIG. 2C shows an exemplary use case where some portion of users (e.g., using UE 10 as shown in FIG. 8) utilize the WCDMA UL transmission scheme with I/Q (In phase/Quadrature) multiplexed pilot and data (e.g., timeslot data 201), and another portion of users utilize the cyclic transport format (e.g., timeslot data 204) in accordance with the exemplary embodiments of this invention. The division may be done, for example, in such a way that users not supporting the cyclic transport format utilize the WCDMA transmission scheme, or users with low UL data rates utilize the conventional WCDMA transmission scheme.

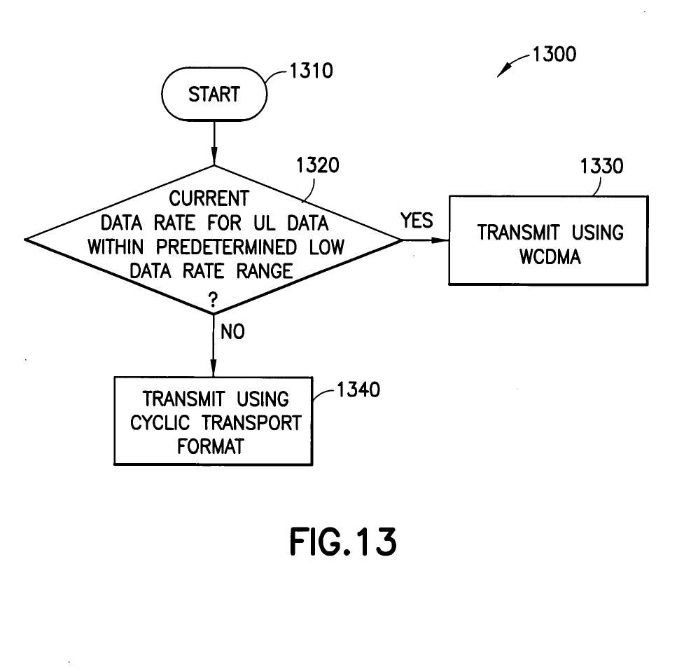

For instance, FIG. 13 shows a method 1300 performed by (e.g., a data processor) of a UE. The method begins in action 1310. In action 1320, it is determined whether the current data rate for UL data is within a predetermined low data range (e.g., is below some predetermined data rate). As examples, the low data range could be e.g., 64 kb/s or 128 kb/s or under. If so (action 1320=YES), the UE transmits using WCDMA (action 133). If not (action 1320=NO), the UE transmits using the cyclic transport format described herein (action 1340).

In one exemplary embodiment, those users utilizing the cyclic transport format transmit the physical layer control signaling (e.g., DPCCH) using the WCDMA transmission scheme, and transmit just the scheduled data using the cyclic transport format, as illustrated in FIG. 2D. One non-limiting benefit of this approach is that implications to the current WCDMA physical layer control signaling, such as PC commands and TFCI, are minimized.

With regard to spreading and mapping, there are two different exemplary options for spreading and mapping: a) FDPA DS CDMA (Frequency Division Pilot Access DS CDMA), (see FIG. 3); and b) IFDMA (see FIGS. 4A-4C). With the both approaches, the mutual orthogonality between the parallel channels is maintained also in a frequency selective channel. IFDMA is obtained using a symbol repetition principle, which can also be utilized for chips (chip repetition (VSCRF CDMA)).

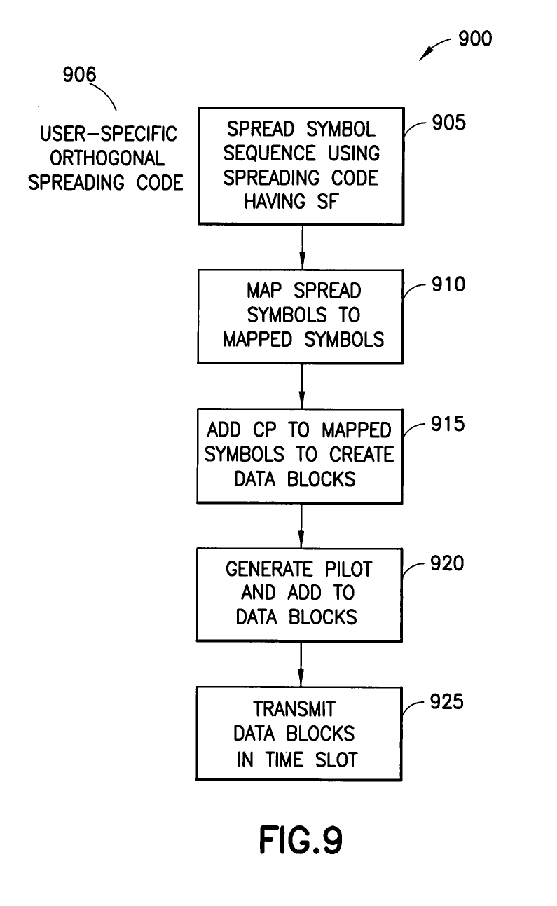

Turning now to FIGS. 3 and 9, in FIG. 3, an example is shown related to realizing orthogonal multiple access between UEs using the cyclic transport format herein for a FDPA DS CDMA (Frequency Division Pilot Access DS CDMA) embodiment (see FIG. 3). In FIG. 9, an exemplary method 900 is shown that performs the realization, and to transmit data in accordance with the realization, of FIG. 3. The method 900 would be performed, e.g., by a data processor in a user equipment, as shown in FIG. 8, discussed below. The symbol sequence 310, including symbols 310-1 through 310-N, are spread (action 905) by using a spreading code 906 having a spreading factor (SF) 301 of eight in this example. The spreading codes 906 are user-specific and can be Walsh-Hadamard codes, CAZAC codes or any other known sequences. The spread symbols 320, including spread symbols 320-1 through 320-N, are mapped (action 910) to mapped symbols 325, which include mapped symbols 325-1 through 325-8.

Cyclic prefixes 345, including cyclic prefixes 345-1 through 345-8, are added (action 915) to create data blocks 330, including data blocks 330-1 through 330-N. A cyclic prefix 325 includes data from the end of the mapped symbols 325. For instance, cyclic prefix 345-1 could include symbol portion S_{N,I} or S_{x,1}, Sₓ₊₁, . . . , S_{N,1}, where x is less than N. A pilot data block 335, including cyclic prefix 336 and pilot data portion 337, is generated and added (action 920) to the data blocks 330. The pilot data portion 337 includes one 338 of the orthogonal reference signals, which are generated in action 920. It is noted that the orthogonal reference signals may be previously generated and accessed in action 920. The pilot data block 335 and data blocks 330 are suitable for filling a timeslot 340, which is equivalent to the timeslot 200 as shown in FIG. 2A. In action 925, the timeslot data 304 (including data blocks 330, 335) are transmitted in the timeslot 340. This transmission is performed under control of, e.g., a data processor.

It is noted that orthogonality is created in FIG. 3 at least by using orthogonal spreading codes 906 with a given spreading factor 301. Different user equipment would be assigned different spreading codes 906 and data from the different user equipment would therefore be orthogonal.

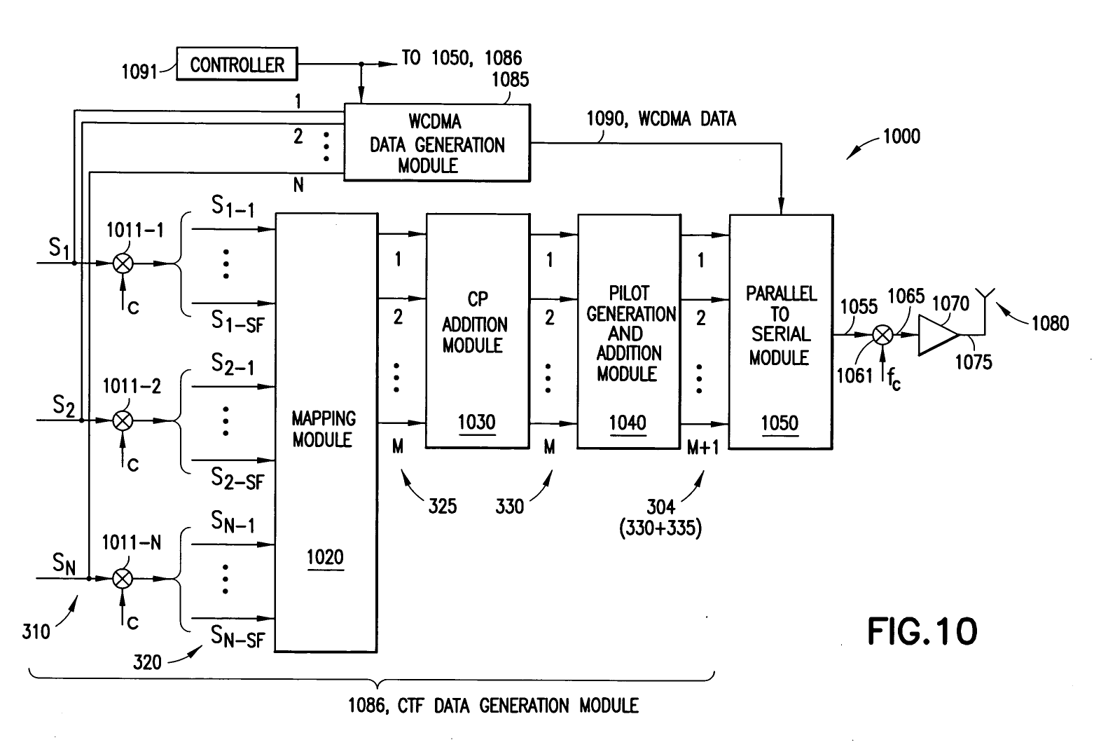

Referring to FIG. 10, this figure shows an exemplary transmitter 1000 suitable for generating cyclic transport format with CDM type of multiple accesses as described in reference to FIG. 3 and also suitable for generating WCDMA data and for transmitting the generated data. The transmitter could be formed as part of, e.g., a user equipment, as shown in FIG. 8, discussed below. In this example of a transmitter 1000, data for transmission is generated using either the WCDMA data generation module 1085 or the CDM type of cyclic transport format (CTF) data generation module 1086. The WCDMA data generation module 1085 produces WCDMA data 1090 (e.g., timeslot data 201 or 202) and the cyclic transport format (CTF) data generation module 1086 produces timeslot data 304. The cyclic transport format data generation module 1086 includes multipliers 1011, a mapping module 1020, a cyclic prefix addition module 1030, and a pilot generation and addition module 1040.

The symbol sequence 310 is spread using spreading code c (i.e., a user-specific orthogonal spreading code 906) |and multipliers 1011, including multipliers 1011-1 through 1011-N. A mapping module 1020 maps the spread symbols 320 to create the mapped symbols 325. In the example of FIG. 3, M was eight, but could be one, two, four, or eight (i.e., factors of the M; M is limited to eight only in this example) and has a limit of the spreading factor 301. The CP addition module 1030 adds a cyclic prefix 345 to create data blocks 330. The pilot generation and addition module 1040 then generates and adds the pilot data block 335 to create a filled timeslot 340, including data blocks 335 and pilot data block 335 that are timeslot data 304. It is noted that the pilot generation and addition module 1040 could also access a previously generated pilot data block 335. A parallel to serial module 1050 converts the parallel data blocks 304 (including 330, 335) or the WCDMA data 1090 to a serial signal 1055 to which a carrier frequency (f_{c}) is added using multiplier (e.g., mixer) 1061 to create a radio frequency signal 1065. An amplifier 1070 amplifies the radio frequency signal 1065 to create amplified radio frequency signal 1075, which is transmitted using antenna 1080.

The parallel to serial module 1050 (e.g., under control of a controller 1091 such as a data processor) selects which data of the WCDMA data 1090 or the timeslot data 304 to transmit. Additionally, a controller 1091 such as a data processor can cause either the WCDMA data generation module 1085 or the cyclic transport format data generation module 1086 to be used.

It is noted that the elements shown in FIG. 10 are merely for expository purposes. For instance, the mapping module 1020 and cyclic prefix addition module 1030 and pilot generation and addition module 1050 could be combined. The functions performed by, e.g., the mapping module 1020 and cyclic prefix addition module 1030 and pilot generation and addition module 1040 could be performed by software, hardware, or some combination thereof. As an example, the mapping module 1020 might be implemented as a circuit on an integrated circuit, while the cyclic prefix addition module 1030 and pilot generation and addition module 1040 could be implemented as software instructions performed by a data processor on the integrated circuit. A typical implementation would have the controller 1091, the WCDMA data generation module 1085, and the cyclic transport format data generation module 1086, implemented by software executed by a data processor, while and the parallel to serial module 1050, multiplier 1061, and amplifier 1070 are performed in hardware.

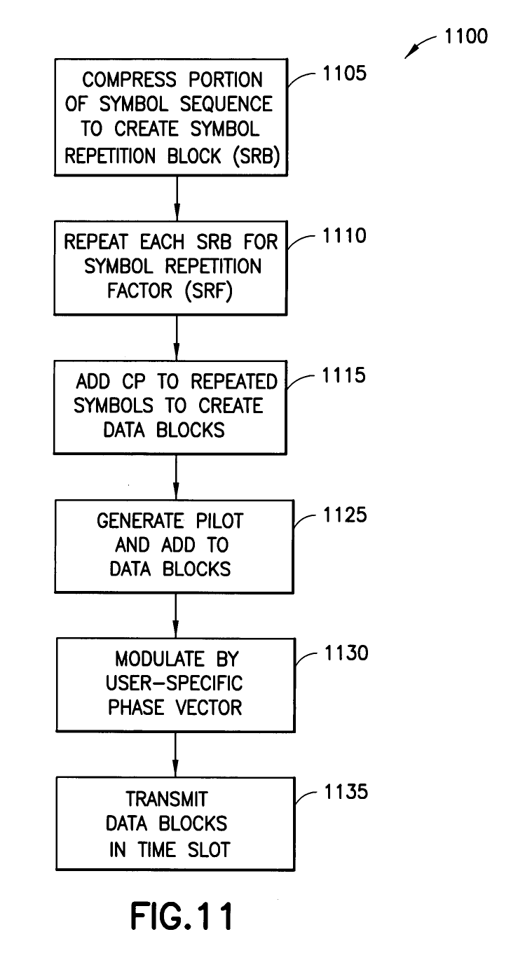

Turning now to FIGS. 2A, 4A-4C and 11, FIG. 4A shows an example related to realization of orthogonal multiple access between UEs using the cyclic transport format for an IFDMA embodiment. FIG. 4B shows an exemplary result of using the symbol repetition and compression of FIG. 4A after modulation (e.g., scrambling) using user-specific phase vectors for two users. FIG. 4C shows an exemplary result of using the symbol repetition and compression of FIG. 4A after modulation using user-specific phase vectors for a single user. FIG. 11 shows a flowchart of an exemplary method 1100 to perform the realization, and to transmit spread and mapped data, of FIGS. 4A-4C. The method 1100 would be performed, e.g., by a data processor in a user equipment, as shown in FIG. 8, discussed below.

In FIG. 4A, a symbol sequence 420 is shown, of which symbols 420-1 through 420-N+1 are shown in this example. A portion 415, which includes N symbols 420-1 through 420-N, is compressed (action 1105) into a symbol repetition block 425. This compression is typically based on data rate. The symbol repetition factor (SRF) acts as a spreading factor. The higher is the repetition/spreading factor, the smaller is the symbol rate (thereby data rate). The symbol repetition block 425 has a size of Q (also N in this example). The symbol repetition block 425 is repeated (action 1110) for symbol repetition factor (SRF) repetitions to create repeated symbols 450, including repeated symbols 450-1 through 450-SRF. In this example, Q*SRF=256, such that the data portion 400 occupies 256 chips and therefore is used as a data portion 230 in the timeslot 200 of FIG. 2A.

In action 1115, a cyclic prefix is added to the repeated symbols 450 to create a data block 230 (see FIG. 2A). As shown in FIG. 2A, there are eight data blocks 230, so actions 1105, 1110, and 1115 create eight data blocks 230. In action 1125, a pilot data block 235 is generated and added to the data blocks 230. As described above, a pilot data block 235 could be previously generated and action 1125 could simply access the previously generated data block.

In action 1130, modulation is performed by applying user-specific (e.g., complex) phase vectors to the data blocks 230, 235. The symbol repetition (e.g., by SRF repetitions) creates the comb-shaped frequency spectrum (e.g., Q pins, SRF-1 zeros). Modulation by the phase vector performs a correct frequency shift for the given frequency spectrum. For multiple users, each of user k and user k+1 would be assigned different user-specific phase vectors 490, 491, respectively. Modulation performed by multiplying the phase vectors 490, 491 for users k and k+1 with the data blocks 230, 235 (e.g., the information in timeslot data 204) from these users has the effect of creating frequency division multiplexing as shown in FIG. 4B. In the example of FIGS. 4B and 4C, Q=6 and SRF=4. Note that the 5 MHz frequency band shown in FIG. 4B is the frequency band typically used by WCDMA in the UL.

In action 1135, the data blocks 230, 235 are transmitted in timeslot 1135. This transmission takes place under control, e.g., of a data processor.

It is noted that the spreading and mapping (CDM) (see, e.g., FIGS. 3 and 9) and block repetition and UE-specific phase modulation (FDM) (see, e.g., FIGS. 4A-4C and 11) are alternative ways to realize orthogonal multiple access between UEs using the cyclic transport format (e.g., of FIG. 2A).

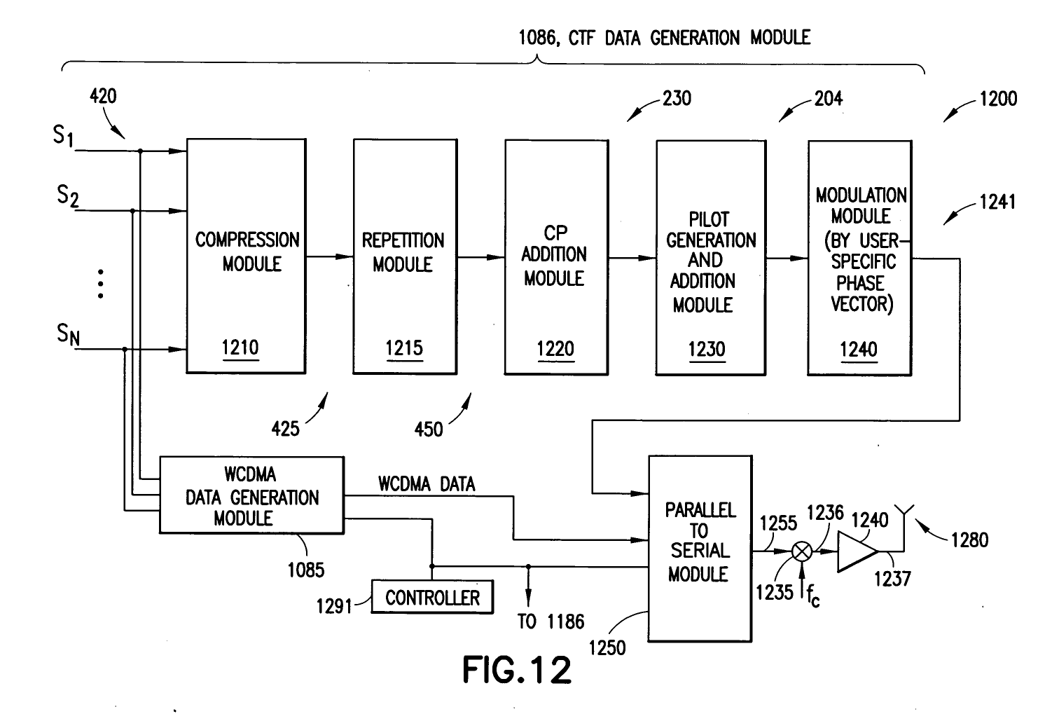

FIG. 12 shows an exemplary transmitter 1200 suitable for generating cyclic transport format data as described in reference to FIGS. 4A-4C and also suitable for generating WCDMA data and for transmitting the generated data. The transmitter 1200 could be part of, e.g., a user equipment, as shown in FIG. 8, discussed below. The transmitter 1200 generates data suitable for transmission by using either the cyclic transport format (CTF) data generation module 1186 or the WCDMA data generation module 1085. The WCDMA generation module 1085 produces WCDMA data 1090 (e.g., timeslot data 201 or 202) and the cyclic transport format data generation module 1186 produces modulated data blocks 1241, and the parallel to serial module 1250 selects between the two data 1090 or 1241. A controller 1291, such as a data processor, controls the parallel to serial module 1250 to select the data 1090 or 1241 and also controls which of the WCDMA data generation module 1085 or cyclic transport format data generation module 1186 is used to generate the data 1090 or 1241, respectively. The cyclic transport format data generation module 1186 includes the compression module 1210, the repetition module 1215, the cyclic prefix addition module 1220, the pilot generation and addition module 1230, and the modulation module 1240.

Transmitter 1200 includes a compression module 1210 that operates to compress (e.g., a portion of) the symbol sequence 420 into Q compressed symbols 425. The repetition module 1215 repeats the compressed symbols SRF times. The cyclic prefix (CP) addition module 1220 operates to add a cyclic prefix 426 to the compressed symbols 430 to create data blocks 230. The pilot generation and addition module 1230 generates pilot data (e.g., or accesses previously generated pilot data) to create a pilot data block 235 and add the pilot data block 235 to the data blocks 230. The modulation module 1240 applies (e.g., multiplies) a user-specific phase vector 490 (see FIG. 4C) to the repeated data blocks 450 to create modulated data blocks 1241. The modulated data blocks 1241 or the WCDMA data 1090 are converted to a serial signal 1255 by the parallel to serial module 1230. The carrier frequency (f_{c}) is added using multiplier (e.g., mixer) 1235 to create a radio frequency signal 1236. An amplifier 1240 amplifies the radio frequency signal 1236 to create amplified radio frequency signal 1237, which is transmitted using antenna 1250.

It is noted that the elements shown in FIG. 12 are merely for expository purposes. For instance, these elements could be combined or further subdivided. The functions performed by these elements could be performed by software, hardware, or some combination thereof.

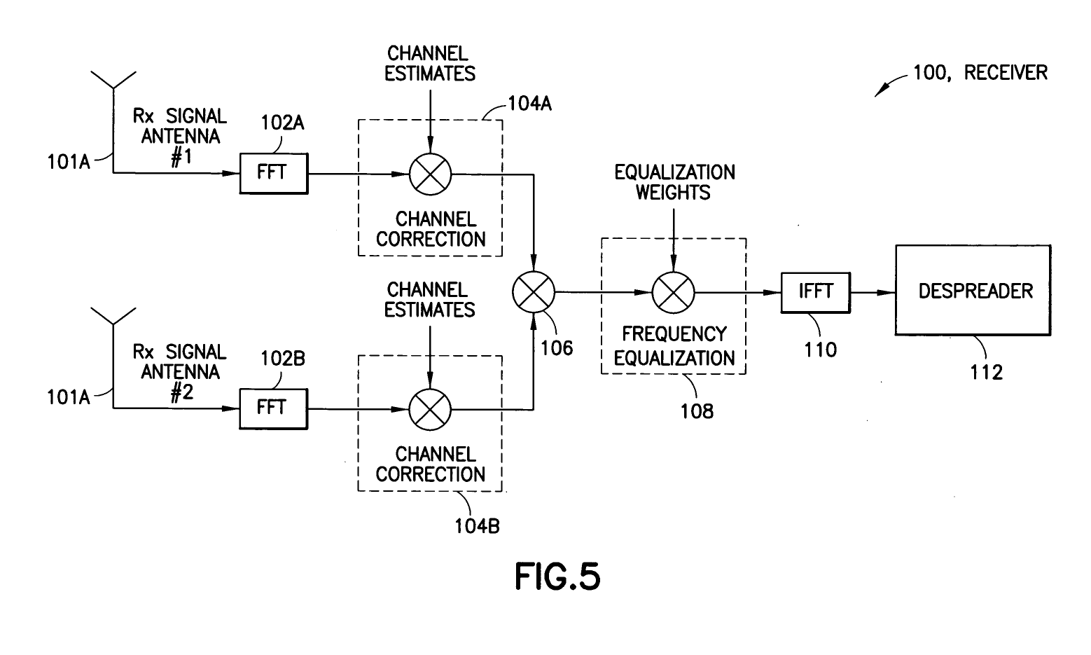

FIG. 5 shows a simplified block diagram of a receiver 100 suitable use with the cyclic transport format. Note that a time domain realization of the receiver 100 is also possible. It is noted that the elements of FIG. 5 may also be considered actions of a method. In FIG. 5 received signals from two antennas 101A, 101B are each applied to a FFT (Fast Fourier Transform) block 102A, 102B and then to channel correction blocks 104A, 104B that receive corresponding channel estimates. The outputs of the channel correction blocks 104A, 104B are summed at 106 and applied to an equalizer 108 that receives equalization weights. The channel corrected, combined and equalized received signal is then applied to IFFT (Inverse Fast Fourier Transform) block 110, the output of which is applied to a despreader module 112. The despreader module 112 functions to, e.g., despread the received data. Two different techniques for spreading data were shown above, and corresponding techniques for despreading data will now be described.

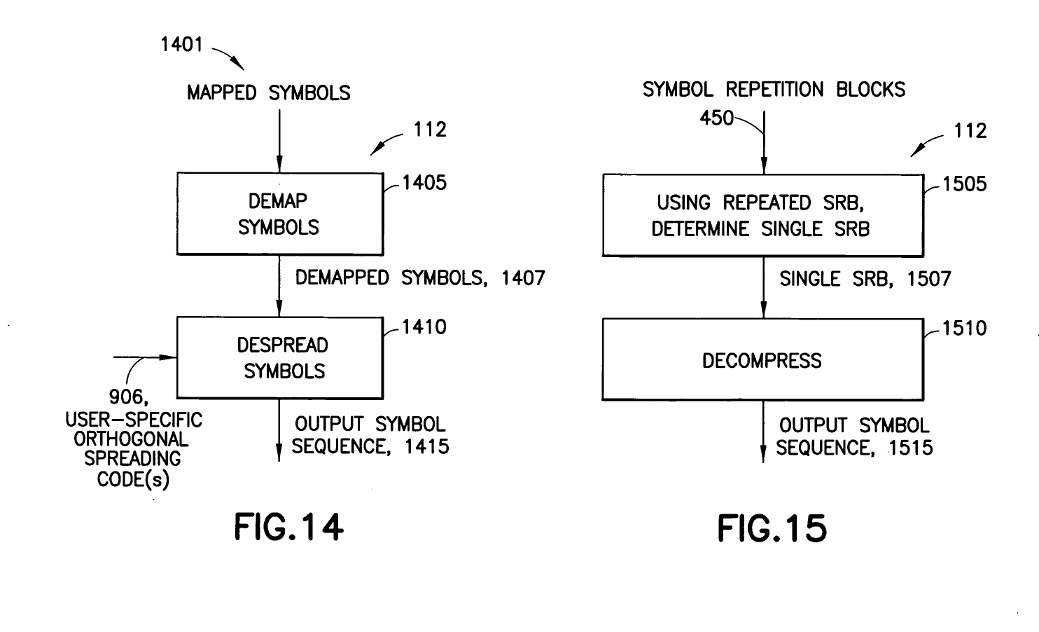

FIG. 14 is a flowchart for despreading data transmitted using the techniques of FIGS. 3 and 9. The blocks in flowchart in FIG. 14 can be considered to be actions performed by a method or elements of the despreader module 112. It is noted that the pilot symbol is removed prior to 112 and goes into forming the channel estimates (see FIG. 5). In block 1405, mapped symbols 1401 (e.g., mapped symbols 325) are demapped. In block 1410, the demapped symbols 1407 are despread, e.g., using one or more user-specific orthogonal spreading codes 906 (see also FIG. 9), to create an output symbol sequence 1415, which should (given no errors) be equivalent to the symbol sequence 310. Typically, signals from multiple users would be received, and therefore multiple user-specific orthogonal spreading codes 906 would be used.

FIG. 15 is a flowchart for despreading data transmitted using the techniques of FIGS. 4A-4C and 11. The blocks in flowchart in FIG. 15 can be considered to be actions performed by a method or elements of the despreader module 112. In this example, symbol repetition blocks 450 (typically, without the cyclic prefix) are used in block 1505 to determined a single symbol repetition block 1507. In block 1510, the single symbol repetition block 1507 is decompressed to create output symbol sequence 1515, which should (given no errors) be equivalent to the symbol sequence 420.

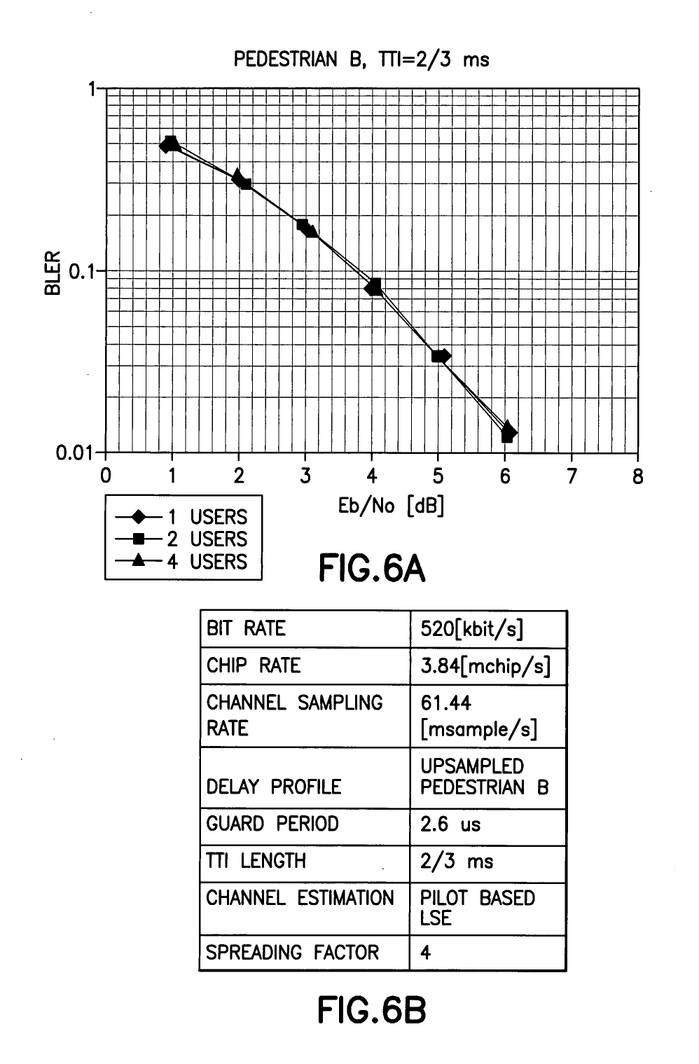

FIG. 6A shows a performance example assuming the conditions listed in the Table of FIG. 6B. Further in this regard it can be noted that FDPA DS CDMA can provide perfect orthogonality between users utilizing the same resource (e.g., frequency selective channel), and that this case is also met with IFDMA.

With respect to various use cases, note that some of the users may utilize the current transport format (i.e., WCDMA), typically low data rate users. The cyclic transport format in accordance with the exemplary embodiments of this invention may replace the transmission scheme of HSUPA, where the DPCCH may be the same as in Release 4 of HSUPA, thereby requiring minimal changes at the physical layer (PHY). Note again that the DPCCH and the cyclic transport formatted signals, in accordance with the exemplary embodiments of this invention, may be transmitted simultaneously, as interference from the DPCCH is not significant.

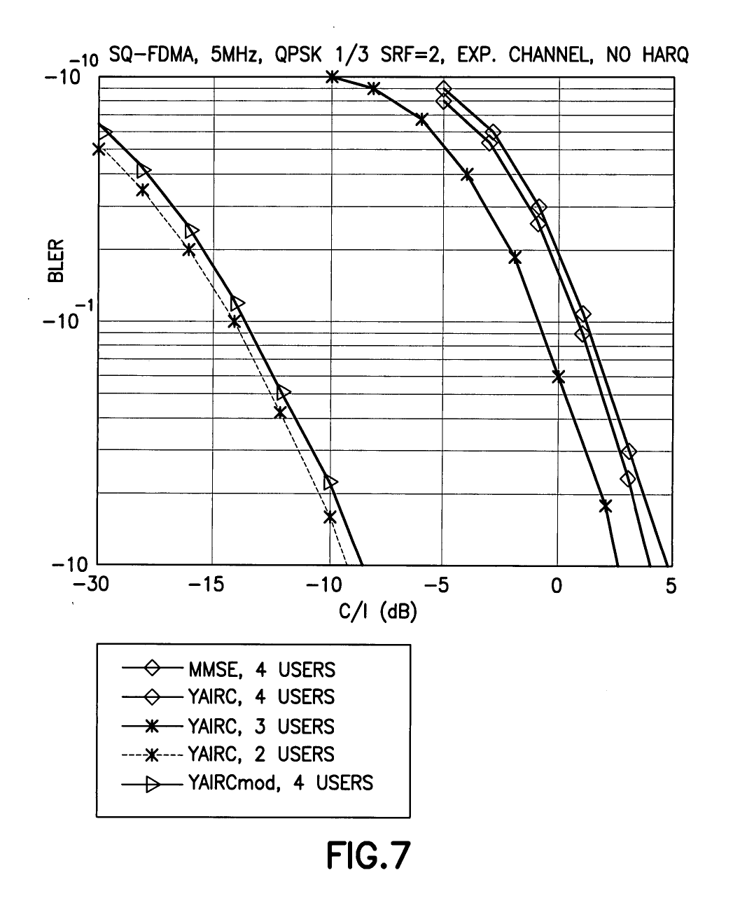

The cyclic transport format in accordance with the exemplary embodiments of this invention may be applied for scheduled users, where IRC may be used to mitigate the interference caused by the dominant interferers. A scheduler is preferably operated in such a way that the interference scenario for IRC becomes favorable. Reference in this regard can be made to FIG. 7 (an IFDMA case with a symbol repetition factor of two and two receive antennas). In FIG. 7, YAIRC is a modified version of IRC capable of handling wideband single-carrier signals.

Using a modified version of IRC, it is possible to increase the IRC potential by cancelling part of the interference by FDMA, and the remainder of the interference by IRC (this type of operation is generally not possible with WCDMA).

Other factors to consider relate to time and frequency synchronization. With regards to time synchronization, in order to maintain orthogonality between different FDPA DS CDMA users all signals should arrive to the BS receivers (e.g., receiver 100 of FIG. 5) within a guard period (e.g., 7.3 microseconds) comprised of a delay dispersion of the radio channel plus a delay dispersion between different users. A timing adjustment may be utilized at least in large cells to facilitate this arrival. With regards to frequency synchronization, it can be noted that the selected symbol length (256) corresponds to a pin separation of 15 kHz. The coarse requirement for frequency synchronization is about plus or minus 1.5 kHz (about 10 percent from pin separation). The selected pin separation provides sufficient resistance against multiple access interference (MAI) caused by Doppler effects.

Implementation of the cyclic transport format in accordance with the exemplary embodiments of this invention may be achieved through the use of a software update for current UE transmitters and BS receivers.

Reference is made to FIG. 8 for illustrating a simplified block diagram of various electronic devices that are suitable for use in practicing the exemplary embodiments of this invention. In FIG. 8, a wireless network 1 is adapted for communication with a UE 10 via a Base Station (BS) 12 and via a wireless link. Exemplary embodiments of the disclosed invention concern the uplink (UL) portion of the wireless link. The network 1 may include at least one network control function (NCF) 14. The UE 10 includes at least one data processor (DP) 10A, a memory (MEM) 10B that stores a program (PROG) 10C, and a suitable radio frequency (RF) transceiver 10D for bidirectional wireless communications with the BS 12 (e.g., a Node B or enhanced Node B) using antenna(s) 10G. The RF transceiver 10D includes a cyclic transport format transmitter 1000, 1200 (described above), a receiver 10E, and a WCDMA transmitter 10F. The transmitters 1000/1200 and 10F are shown separately, but will typically be the same transmitter 10K. In this example, the memory 10B and data processor 10A are formed as part of an integrated circuit 10H, and the RF transceiver is formed as part of one or more additional integrated circuits 10J.

The wireless network 1 also includes a “legacy” UE 16 that includes a MEM 16B, a Prog 16C, a DP 16A, an RF transceiver 16D and an antenna 16G. The transceiver 16D includes a receive 16E and a WCDMA transmitter 16F. The UE 16 is considered a legacy UE because the UE 16 supports only WCDMA transmission and does not support the cyclic transport format transmissions described herein.

The BS 12 includes a DP 12A, a MEM 12B that stores a PROG 12C, and a suitable RF transceiver 12D. The BS 12 includes or is coupled to antenna(s) 12G. The transceiver 12D includes in this example a transmitter 12E, a cyclic transport format receiver 100, and a WCDMA receiver 12F. Although the cyclic transport format receiver 100 and WCDMA receiver 12F are shown separately, these would typically be the same receiver 12K. In this example, the DP 12A and MEM 12B are formed as part of an integrated circuit 12H, and the transceiver 12D is formed as one or more additional integrated circuits 12J.

The BS 12 is coupled via a data path 13 to the NCF 14 that also includes a DP 14A and a MEM 14B storing an associated PROG 14C. At least the PROGs 10C and 12C are assumed to include program instructions that, when executed by the associated DP, enable the electronic device to operate in accordance with the exemplary embodiments of the invention so as to transmit and receive the UL cyclic transport formatted waveform, as described above. The embodiments of this invention may be implemented by computer software executable by the DP 10A of the UE 10 and the DP 12A of the BS 12, or by hardware, or by a combination of software and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B, and 14B may be of any type suitable to the local technical environment and may be implemented using any suitable data storage technology, such as semiconductor based memory devices, magnetic memory devices and systems, optical memory devices and systems, fixed memory and removable memory. The DPs 10A, 12A, and 14A may be of any type suitable to the local technical environment, and may include one or more of general purpose computers, special purpose computers or circuits, microprocessors, digital signal processors (DSPs) and processors based on a multi-core processor architecture, as non limiting examples. A computer program product, e.g., as part of MEM 10B, 12B, and 14B, may also be included. The computer program product tangibly embodies a program of machine-readable instructions executable by one or more data processors to perform operations described herein. Such a computer program product could be part of a MEM, a digital versatile disk (DVD), compact disk (e.g., CDROM), memory stick, or any other short- or long-term memory.

In terms of signaling from the base station 12 to the UE 10 to support exemplary embodiments herein, signaling information from the base station 12 to the UE 10 may include the following information elements:

1) For IFDMA, the signaling information can include the chip/symbol repetition factor and the phase vector or index for the phase vector; and

2) For FDPA-DS-CDMA, the signaling information can include the spreading factor and the spreading code or index for the spreading code.

Additionally, information related to the used modulation and coding and HARQ scheme is also typically needed at the UE 10.

A number of advantages can be realized through the use of the exemplary embodiments of this invention as described above. For example, in a UTRAN LTE context capacity gains of the order of 100% to 200% can be achieved, as compared to HSUPA. Since the radio performance of the cyclic transport format is close to that of the UTRAN LTE UL, it is reasonable to assume that a majority of the UL gain provided by the cyclic transport format should be obtainable as well in the HSUPA system that is of particular interest to this invention.

In addition, UL MIMO techniques are facilitated since the pilots of the multiple data streams can be orthogonalized by means of IFDMA. As a result, the potential to deploy MIMO is higher than with only a WCDMA approach. In addition, on top of MIMO higher order modulations can be employed as well.

The use of the cyclic transport format in accordance with the exemplary embodiments of this invention also provides a smooth upgrade path for current 3G users.

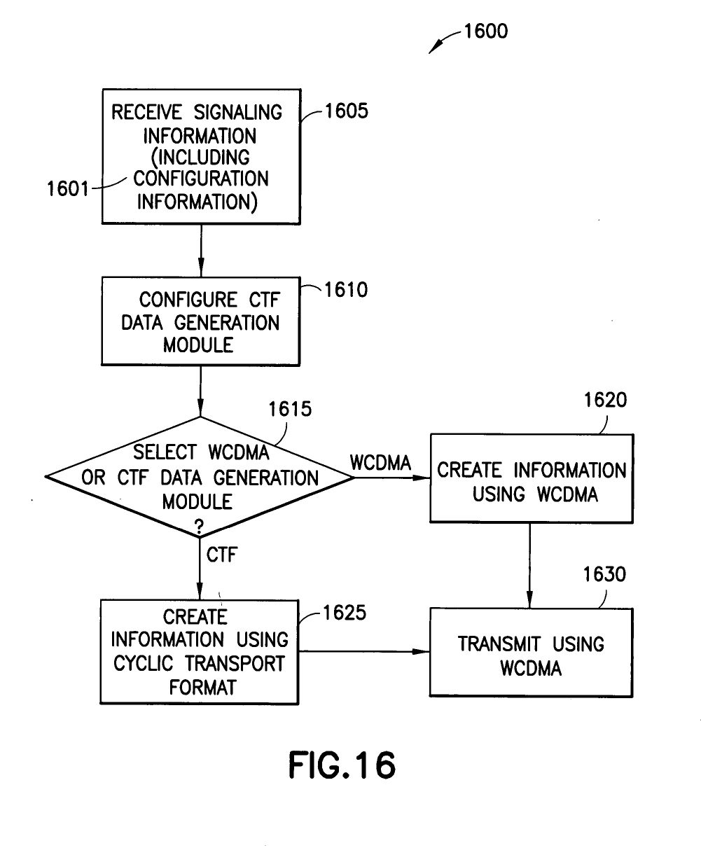

In FIG. 16, a flowchart of a method 1600 is shown for creating and transmitting data using either a WCDMA transport format or cyclic transport format. Method 1600 would be performed by, e.g., UE 10 (e.g., DP 10A). In action 1605, the UE 10 receives signalling from the BS 12. The signalling information can include numbers 1) and 2) above. Additionally, configuration information 1601 can be included, such as whether the UE 10 is to be configured to perform one of FIGS. 2C, 2D, or 13. In action 1610, the UE 10 configures the cyclic transport format data generation module to create, e.g., cyclic transport format data generation module 1086 or 1186.

In action 1615, the UE 10 selects either the WCDMA data generation module 1085 or the cyclic transport format data generation module (e.g., 1086/1186). If WCDMA is selected, in action 1620, the WCDMA data generation module 1085 generates WCDMA information from an input symbol sequence. If cyclic transport format is selected, in action 1625, the cyclic transport format data generation module (e.g., 1086/1186) generates cyclic transport format information from an input symbol sequence. In block 1630, the information is transmitted in the timeslot. It is noted that a combination of creating information and transmitting information causes the transmitted information to be transmitted in a particular frequency band. For instance, for creation of cyclic transport format information based on cyclic CDM, the operations shown in FIG. 3 cause the cyclic transport format information (e.g., timeslot data 304) to have a certain frequency band, but the multiplication by the carrier frequency, f_{c}, further modifies the location of the frequency band to occupy another frequency band.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
selecting either a first transport format or a second transport format to transmit information corresponding to an input symbol sequence, each of the transport formats fitting information for transmission into a timeslot having a predetermined duration; and
based upon the selected transport format, either creating the information for transmission from the input symbol sequence using the first transport format or creating the information for transmission from the input symbol sequence using the second transport format, wherein creating the information for transmission using the first transport format comprises applying at least one spreading code to the input symbol sequence; and
transmitting the information for transmission in a selected timeslot having the predetermined duration, wherein creating and transmitting the information using the first transport format causes the transmitted information to occupy a first frequency band, and wherein creating and transmitting the information using the second transport format causes the transmitted information to occupy a second frequency band that at least partially overlaps the first frequency band.

2. The method of claim 1, wherein the method is performed by a first apparatus and wherein creating the information for transmission using the second transport format is performed so that the transmitted information is orthogonal to second information transmitted by another apparatus performing the method to transmit the second information using the second transport format.

3. The method of claim 2, wherein orthogonality is created at least by using different spreading codes having spreading factors for each of the first and other apparatus, the spreading codes applied during creating the information for transmission from the input symbol sequence using the second transport format.

4. The method of claim 3, wherein the spreading codes comprise one of constant amplitude zero autocorrelation codes or Walsh-Hadamard codes.

5. The method of claim 2, wherein orthogonality is created at least by using different phase vectors for each of the first and other apparatus, the phase vectors applied during creating the information for transmission from the input symbol sequence using the second transport format.

6. The method of claim 1, wherein each transport format has the duration of ⅔ millisecond, includes 2560 chips used to store information, and is transmitted using a chip rate of 3.84 million chips per second.

7. The method of claim 1, wherein the second transport format comprises a plurality of data blocks having cyclic prefixes, and wherein creating the information for transmission from the input symbol sequence using the second transport format further comprises:
spreading a plurality of symbols in the symbol sequence using a user-specific spreading code having a spreading factor;
mapping the spread symbols into a number of mapped symbols, each mapped symbol comprising a portion of one of the plurality of spread symbols;
adding a cyclic prefix to each of the mapped symbols to create data blocks; and
adding a pilot data block, comprising a pilot symbol and a cyclic prefix, to the data blocks to create the information for transmission.

8. The method of claim 7, wherein the number of mapped symbols is less than or equal to the spreading factor.

9. The method of claim 1, wherein the second transport format comprises a plurality of data blocks having cyclic prefixes, and wherein creating the information for transmission from the input symbol sequence using the second transport format further comprises:
compressing a plurality of symbols in the symbol sequence into a symbol repetition block;
repeating the symbol repetition block a first predetermined number of times to create repeated blocks;
adding a cyclic prefix to the repeated blocks to create a data block;
performing compressing, repeating, and adding a second predetermined number of times in order to create a predetermined number of data blocks;
adding a pilot data block, comprising a pilot symbol and a cyclic prefix, to the data blocks; and
using a phase vector, modulating the data blocks and the pilot data block to create the information for transmission.

10. The method of claim 1, wherein selecting further comprises selecting the first transport format in response to a data rate being within a first data rate range and selecting the second transport format in response to the data rate being within a second data rate range.

11. The method of claim 1, wherein selecting further comprises selecting the first transport format in response to a scheduled transmission of physical layer control signaling and selecting the second transport format in response to a scheduled transmission of data.

12. An apparatus comprising:
a controller configured to select either a first transport format or a second transport format to transmit information corresponding to an input symbol sequence, each of the transport formats fitting information for transmission into a timeslot having a predetermined duration; and
at least one transmitter configured, responsive to the controller and based upon the selected transport format, either to create the information for transmission from the input symbol sequence using the first transport format or to create the information for transmission from the input symbol sequence using the second transport format, wherein the at least one transmitter is configured, when creating the information for transmission using the first transport format, to apply at least one spreading code to the input symbol sequence, the at least one transmitter configured to transmit the information for transmission in a selected timeslot having the predetermined duration, wherein creation and transmission of the information using the first transport format causes the transmitted information to occupy a first frequency band, and wherein creation and transmission of the information using the second transport format causes the transmitted information to occupy a second frequency band that at least partially overlaps the first frequency band.

13. The apparatus of claim 12, wherein the controller and at least one transmitter are formed at least in part on at least one integrated circuit.

14. The apparatus of claim 12, wherein the at least one data processor is further configured to create the information using the second transport format so that the transmitted information is orthogonal to information transmitted by other apparatus using the second transport format.

15. The apparatus of claim 12, wherein each transport format has the duration of ⅔ millisecond, includes 2560 chips used to store information, and is transmitted using a chip rate of 3.84 million chips per second.

16. The apparatus of claim 12, wherein the second transport format comprises a plurality of data blocks having cyclic prefixes, and wherein the at least one transmitter comprises:
a plurality of multipliers configured to multiply a plurality of symbols in the symbol sequence by a user-specific code having a spreading factor, the plurality of multipliers creating a plurality of spread symbols;
a mapping module configured to map the spread symbols into a number of mapped symbols, each mapped symbol comprising a portion of one of the plurality of spread symbols;
a cyclic prefix addition module configured to add a cyclic prefix to each of the mapped symbols to create data blocks; and
a pilot addition module configured to add a pilot data block, comprising a pilot symbol and a cyclic prefix, to the data blocks to create the information for transmission.

17. The apparatus of claim 12, wherein the second transport format comprises a plurality of data blocks having cyclic prefixes, and wherein the at least one transmitter comprises:
a compression module configured to compress a plurality of symbols in the symbol sequence into a symbol repetition block;
a repetition module configured to repeat the symbol repetition block a first predetermined number of times to create repeated blocks;
a cyclic prefix addition module configured to add a cyclic prefix to the repeated blocks to create a data block, wherein the compression module, repetition module, and cyclic prefix addition module operate in order to create a predetermined number of data blocks;
a pilot addition module configured to add a pilot data block, comprising a pilot symbol and a cyclic prefix, to the data blocks; and
a modulation module configured to use a phase vector to modulate the data blocks and the pilot data block to create the information for transmission.

18. The apparatus of claim 12, wherein the controller is configured to select the first transport format in response to a data rate being within a first data rate range and to select the second transport format in response to the data rate being within a second data rate range.

19. The apparatus of claim 12, wherein the controller is configured to select the first transport format in response to a scheduled transmission of physical layer control signaling and to select the second transport format in response to a scheduled transmission of data.

20. A computer program product tangibly embodying a program of machine-readable instructions executable by at least one data processor to perform operations comprising:
selecting either a first transport format or a second transport format to transmit information corresponding to an input symbol sequence, each of the transport formats fitting information for transmission into a timeslot having a predetermined duration; and
based upon the selected transport format, either creating the information for transmission from the input symbol sequence using the first transport format or creating the information for transmission from the input symbol sequence using the second transport format, wherein creating the information for transmission using the first transport format comprises applying at least one spreading code to the input symbol sequence;
transmitting the information for transmission in a selected timeslot having a predetermined duration, wherein creating and transmitting the information using the first transport format causes the transmitted information to occupy a first frequency band, and wherein creating and transmitting the information using the second transport format causes the transmitted information to occupy a second frequency band that at least partially overlaps the first frequency band.

21. The computer program product of claim 20, wherein the operations are performed by a first apparatus and wherein the operation of creating the information for transmission using the second transport format is performed so that the transmitted information is orthogonal to second information transmitted by another apparatus performing the operations to transmit the second information using the second transport format.

22. The computer program product of claim 20, wherein each transport format has the duration of ⅔ millisecond, includes 2560 chips used to store information, and is transmitted using a chip rate of 3.84 million chips per second.

23. A method comprising:
receiving first information using a first transport format, the first information received in a timeslot having a predetermined duration, wherein the first information occupies a first frequency band;
converting, at least by applying at least one spreading code to the received first information, the received first information to first output data;
receiving second information using a second transport format, the second information received in a timeslot having the predetermined duration, wherein the second information occupies a second frequency band that at least partially overlaps the first frequency band, and wherein the first and second information are received at the same time in a selected timeslot; and
converting the received second information to second output data.

24. The method of claim 23, wherein the second transport format comprises a plurality of data blocks having cyclic prefixes, wherein receiving second information comprises receiving at least one time-domain signal using at least one antenna, and wherein converting the received second information to second output data comprises:
transforming each of the at least one time-domain signals to a corresponding frequency-domain signal;
for each of the frequency-domain signals, applying channel estimates to a corresponding one of the frequency-domain signals to create a corresponding channel corrected signal;
applying equalization weights to all of the channel corrected signals to create an equalized signal;
transforming the equalized signal to a second time-domain signal; and
despreading the second time-domain signal to create the second output data.

25. The method of claim 24, wherein despreading further comprises demapping symbols in the second time domain signal to create demapped symbols and, using at least one orthogonal spreading code, despreading the demapped signals to create the second output data.

26. The method of claim 24, wherein despreading further comprises determining a single symbol repetition block from a plurality of symbol repetition blocks in the second time-domain signal and decompressing the single symbol repetition block to create the second output data.

27. An apparatus comprising:
a first receiver configured to receive first information using a first transport format and to convert, at least by application of at least one spreading code to the received first information, the received first information to first output data, the first information received in a timeslot having a predetermined duration, wherein the first information occupies a first frequency band;
a second receiver configured to receive second information using a second transport format and to convert the received second information to second output data, the second information received in a timeslot having the predetermined duration, wherein the second information occupies a second frequency band that at least partially overlaps the first frequency band, and wherein the first and second information are received at the same time in a selected timeslot.

28. The apparatus of claim 27, wherein the first and second receivers are formed at least in part on at least one integrated circuit.

29. The apparatus of claim 27, wherein the second transport format comprises a plurality of data blocks having cyclic prefixes, the apparatus comprises at least one antenna receiving at least one time-domain signal, and wherein the second receiver comprises:
a first transform device for each of the at least one antennas, each first transform device configured to transform a corresponding one of the at least one time-domain signals to a corresponding frequency-domain signal;
a channel correction device for each of the first transform devices, each channel correction device configured to apply channel estimates to a corresponding one of the frequency-domain signals to create a corresponding channel corrected signal;
a frequency equalization device configured to apply equalization weights to all of the channel corrected signals to create an equalized signal;
a second transform device configured to transform the equalized signal to a second time-domain signal; and
a despreader module configured to despread the time-domain signal.

30. The apparatus of claim 29, wherein the despreader module is configured to demap symbols in the second time domain signal to create demapped symbols and is configured, using at least one orthogonal spreading code, to despread the demapped signals to create the second output data.

31. The apparatus of claim 29, wherein the despreader module is configured to determine a single symbol repetition block from a plurality of symbol repetition blocks in the second time-domain signal and to decompress the single symbol repetition block to create the second output data.

32. An apparatus comprising:
at least one transmitter configured to create information for transmission from an input symbol sequence using a first transport format, the at least one transmitter configured to transmit the information for transmission in a timeslot having a predetermined duration, wherein creation and transmission of the information using the first transport format causes the transmitted information to occupy a first frequency band that at least partially overlaps a second frequency band occupied when a second transport format is used by other apparatus to transmit information within a timeslot having the predetermined duration, wherein creation of the information uses a user-specific code that provides orthogonality of the transmitted information relative to information created and transmitted using other user-specific codes, and wherein transmissions using the second transport format multiplex users through non-orthogonal user-specific spreading codes.

33. The apparatus of claim 32, wherein the at least one transmitter is formed at least in part by at least one integrated circuit.

34. The apparatus of claim 32, wherein the user-specific code is a spreading code having a spreading factor.

35. The apparatus of claim 34, wherein the spreading code comprises one of constant amplitude zero autocorrelation codes or Walsh-Hadamard codes.

36. The apparatus of claim 32, wherein the user-specific code is a phase vector.

37. The apparatus of claim 32, wherein each transport format has the duration of ⅔ millisecond, includes 2560 chips used to store information, and is transmitted using a chip rate of 3.84 million chips per second.

38. The apparatus of claim 32, wherein the first transport format comprises a plurality of data blocks having cyclic prefixes.
